(19) United States
(12) Patent Application Publication
(10) Pub. No.: US 2013/0187302 A1
(43) Pub. Date: Jul. 25, 2013

(54) Investment Composition Materials Having a Reducing Agent

(71) Applicants: Tsadok Tsadok Hai, Grootebroek (NL); Bastiaan Phillip Van Dijk, Alkmaar (NL); Marcel André De Kler, Heiloo (NL)

(72) Inventors: Tsadok Tsadok Hai, Grootebroek (NL); Bastiaan Phillip Van Dijk, Alkmaar (NL); Marcel André De Kler, Heiloo (NL)

(21) Appl. No.: 13/354,654

(22) Filed: Jan. 20, 2012

(51) Int. Cl. A61C 13/00; B28B 7/36; C01B 31/04

(52) U.S. Cl. 264/16; 423/445 R; 423/448; 106/35

(57) ABSTRACT

An investment composition comprising a reducing agent containing carbon.

### FIELD OF INVENTION

The present invention is directed to a method for the manufacture of dental restorations using an investment, and specifically to a composition for forming an investment material.

### BACKGROUND OF THE INVENTION

In the dental treatment, the formation of a dental restoration such as an inlays, onlays, crowns, and veneers is employed. For producing such dental restoration, a dental investment mold (e.g., investment block) is employed. For producing such a dental investment mold, a suitable amount of liquid is added to a dental investment material, which is then cast into a frame containing a wax pattern having a desired tooth pattern as a core and then allowed to solidify, and thereafter sintered at a high temperature.

Typical investment molds (e.g., phosphate-based and/or gypsum-based molds) can be readily cast into the frame, undergoes a less deformation due to the residual stress after sintering, allows a molded article to be released readily after casting and does not change significantly over time.

However, reactions between the investment mold and the restoration material occur thereby forming an undesirable reaction layer about the surface of the restoration material during formation of the restoration. Accordingly, to remove the reaction layer from the formed restoration (e.g., sprue) one or more additional finishing procedures may be required, which add additional time and cost to the manufacturing of the restoration. One particular additional finishing step to remove the reaction layer is acid etching. The acid etching step can be an undesirable finishing step due to the acidity of the acid, which requires caution during the handling thereof, and the additional time it takes to immerse the formed restoration in the acid to soften the reaction layer for removal.

In view of the problems described above, an objective of the invention is to provide a dental investment material having a reducing agent and a method for producing a dental investment mold that reduces or substantially eliminates the formation of a reaction layer during the formation of the restoration.

### SUMMARY OF THE INVENTION

The present invention seeks to improve upon prior investment materials by providing an improved composition for manufacturing an investment material. In one aspect, the present invention provides an investment composition comprising a reducing agent containing carbon.

In another aspect, the present invention contemplates a method for manufacturing a heat-resistant mold for manufacturing a dental restoration comprising the steps of: creating a wax model; providing a heat-resistant material comprising a reducing agent containing carbon; applying the heat resistant material to the wax model; heating the wax model covered with the heat resistant material so that the wax is burnt off thereby forming a heat resistant mold having a void therein; providing a restoration material into the void of the heat resistant mold; and forming a resultant restoration in the void of the heat resistant mold; wherein the formation of a reaction layer is reduced or substantially eliminated along the surface of the resultant restoration as compared to a restoration formed from a heat resistant material being free of a reducing agent containing carbon.

In another aspect, the present invention contemplates an investment composition comprising: from about 0.5% to about 10% by wt graphite; from about 10% to about 45% by wt at least one binder; from about 45% to about 80% by wt at least one refractory material; and from about 15% to about 35% by wt at least one liquid component.

In yet another aspect, any of the aspects of the present invention may be further characterized by one or any combination of the following features: wherein the reducing agent is graphite; wherein the reducing agent is present in an amount ranging from about 0.5% to about 50%; wherein the reducing agent is present in an amount ranging from about 0.5% to about 25%; further comprising at least one binder and at least one refractory material, wherein the at least one binder is present in an amount ranging from about 3% to about 65% and the at least one refractory material is present in an amount ranging from about 25% to about 95%; further comprising at least one binder and at least one refractory material; wherein the at least one binder is present in an amount ranging from about 3% to about 65%; wherein the at least one binder is present in an amount ranging from about 10% to about 45%; wherein the at least one refractory material is present in an amount ranging from about 25% to about 95%; wherein the at least one refractory material is present in an amount ranging from about 45% to about 80%; wherein the reducing agent is present in an amount ranging from about 0.5% to about 15%; wherein the at least one binder includes a first binder and a second binder that is different from the first binder; wherein the first binder is present in an amount ranging from about 1% to about 30% and the second binder is present in an amount ranging from about 1% to about 30%; wherein the at least one refractory material includes a first refractory material and a second refractory material that is different from the first refractory material; wherein the first refractory material is present in an amount ranging from about 30% to about 75% and the second refractory material is present in an amount ranging from about 3% to about 60%; further comprising one or more liquid components being present in an amount ranging from about 5% to about 45%; further comprising one or more liquid components being present in an amount ranging from about 15% to about 35%; wherein the reducing agent is graphite and is present in an amount ranging from about 0.5% to about 15%; wherein the reducing agent is present in an amount ranging from about 0.1% to about 25% by wt of the heat-resistant material; wherein the heat-resistant material further comprises at least one binder and at least one refractory material; wherein the at least one binder is present in an amount ranging from about 10% to about 45% by wt of the heat-resistant material; wherein the at least one refractory material is present in an amount ranging from about 45% to about 80% by wt of the heat-resistant material; wherein the reducing agent is present in an amount ranging from about 0.5% to about 15% by wt of the heat-resistant material; wherein the first binder is present in an amount ranging from about 1% to about 30% by wt of the heat-resistant material and the second binder is present in an amount ranging from about 1% to about 30% by wt of the heat-resistant material; wherein the first refractory material is present in an amount ranging from about 30% to about 75% by wt of the heat-resistant material and the second refractory material is present in an amount ranging from about 3% to about 60% by wt of the heat-resistant material; wherein the heat-resistant material further comprises one or more liquid components being present in an amount ranging from about 15% to about 35%; wherein the reducing agent is graphite and is present in an amount ranging from about 0.5% to about 15% by wt of the heat-resistant material; wherein the reducing agent reduces the formation of the reaction layer so that the reaction layer is present having a thickness ranging from about 0 microns to about 100 microns along the surface of the resultant restoration; wherein the reducing agent reduces the formation of the reaction layer so that the reaction layer is present having a thickness ranging from about 0.5 microns to about 30 microns along the surface of the resultant restoration; wherein the reducing agent reduces the formation of the reaction layer so that the reaction layer is present having a thickness ranging from about 0.5 microns to about 10 microns along the surface of the resultant restoration; wherein the method is free of an acid etching step; wherein the at least one binder includes a first binder ranging from about 3% to about 20% by wt of the investment composition and a second binder ranging from about 3% to about 20% by wt of the investment material; wherein the at least one refractory material includes a first refractory material ranging from about 35% to about 65% by wt of the investment composition and a second refractory material ranging from about 5% to about 35% by wt of the investment material; wherein the at least one liquid component includes a first liquid component ranging from about 10% to about 30% by wt of the investment composition and a second liquid component ranging from about 3% to about 20% by wt of the investment material; or any combination thereof.

It should be appreciated that the above referenced aspects and examples are non-limiting as others exist with the present invention, as shown and described herein. For example, any of the above mentioned aspects or features of the invention may be combined to form other unique configurations, as described herein, demonstrated in the drawings, or otherwise.

### DETAILED DESCRIPTION OF INVENTION

The invention relates to a method for manufacturing a heat-resistant mold for manufacturing a dental restoration, wherein a wax model is manufactured from a powdered heat-resistant material in a conventional manner. The invention further relates to an investment material, and in particular to a carbon-containing (e.g., graphite-containing) heat-resistant investment material. This material is used in dentistry and especially in dental laboratories for manufacturing molds, and in particular compression and casting molds.

For manufacturing inlays, crowns, bridges, prostheses and other types of dental restoration, in general an impression of the teeth is made by use of specific impression compositions. The thus obtained forms are used to make a model of the teeth, by means of which model the restoration is modeled.

The restoration to be manufactured can be formed by use of, for example, the so-called lost wax method by means of a wax model and heat-resistant investment compositions. For this purpose, the restoration is shaped by means of casting or compression in a heat-resistant investment composition. This technique had long been used for the casting of metal restorations and, for some ten years now, also for compressing glass-ceramic restorations.

The formation of a dental restoration by the lost wax technique generally includes one or more of the following steps:

Creating an impression (e.g., negative mold) of the prepared tooth. An impression material such as a hydrocolloid, polyester rubber, vinyl polysilicone (VPS), or otherwise may be used to make an impression of the prepared teeth.

Formation of a stone model to create a positive replica of the tooth. The impression may be then used by the laboratory technician to create a stone or epoxy model with removable dies that were an accurate copy of the prepared tooth.

Application of a spacer (e.g., die spacer) to a die, which affords appropriate relief in a range of 20 to 36 microns or otherwise to allow space for a dental cement or bonding agent to secure the final restoration to the patient's prepared tooth.

Applying a lubricant or a release agent over the die spacer.

Fabrication a wax model of the dental restoration over the lubricated die. More particularly, the wax may be built up over the stone model of the tooth to the desired dimension of the final restoration.

Mounting the wax model on a pedestal connected to a ring former base. The model may be mounted on the pedestal using a wax sprue. Several restorations may be mounted on a single pedestal using one sprue per restoration. The sprues are generally mounted at an angle of between 30° and 60° with respect to the upper surface of the pedestal. The pedestal and sprue elevate the model up from the ring former base, suspending the model in the air. In order to determine the amount of ceramic required to form the restoration, the model(s) and sprue(s) are weighed. This is typically accomplished by weighing the ring former/pedestal without the sprues and models, weighing ring former/pedestal and sprues and models together, and then subtracting the former from the latter.

Investing the wax model once removed from the stone model in high heat graphite based investment or refractory material. A ring may be then placed around the pedestal on the ring former base. The ring fits snugly on a raised portion of the ring former base. The ring completely encompasses the pedestal, sprues, and models. Typically, at least 10 mm clearance may be provided for all around the model(s) by the ring, which is typically made of paper but can also be made of an elastomer. The size of the ring is typically chosen based on the determined weight of the wax. A stabilizer ring may be placed over the upper rim of the ring in order to provide additional support. The ring may be then filled with a castable refractory material, also known as investment, which is further described below. Typically, the ring volume may be slowly filled to ensure there is minimal formation of air bubbles in the investment material. Optionally, portions of the mold form or all areas of the mold form that may come into contact with the investment material or refractory material may be lubricated to prevent adhesion to the refractory. Examples of lubricants may include, but are not limited to petroleum jelly, a Teflon-Silicone spray, or otherwise.

The investment material is then allowed to solidify resulting in a refractory material cylinder (e.g., investment block). It is appreciated that other geometric shapes (e.g., cylinder, cube, or otherwise) are contemplated in forming the investment block. Typically, solidification may require about ten to thirty minutes or more of set time depending on ambient conditions. The refractory material cylinder is then removed from the ring former base/pedestal and the leveling ring. This is typically accomplished by twisting the base/pedestal and the leveling ring so as to break away the refractory material from the surfaces of each. The paper ring is then removed. Any roughness on the mold is then removed by a cutting instrument. The paper ring may also leave a seam down the side of the refractory material cylinder. This seam can be smoothed in a similar manner.

The investment (e.g., refractory) material cylinder encompassing the wax sprue(s) and model(s) is then placed in a burnout furnace or oven. The cylinder is placed with the pedestal opening down. The burnout oven is typically set at a temperature ranging from about 600° C. to about 900° C. In this heated environment, the wax composing the sprue(s) and model(s) melts and then burns or evaporates off through the void created by the pedestal. A cylinder of the investment material remains with a negative of the shape of the model connected to a passageway, created by the void left by the pedestal, via the void left by the sprue. The pedestal can also be made of wax and detachable from the ring former base. In this case, the pedestal is not lubricated and does not break off with the base but remains inside the refractory material cylinder. The wax pedestal is then burned off as described above leaving the void described above.

It is appreciated that the present invention may be utilized with ceramics or alloys. In one example an alloy may then be casted into the model negative (restoration mold) through the void left by the pedestal. More particularly, the present invention contemplates a process for the manufacture of a dental restoration such as a crown or a bridge, comprising a substructure of a dental metal and a fired on coating of a dental ceramic material. The process may comprise mixing a powder substantially of dental metal to form a paste-like slurry, placing on a refractory model (e.g., model formed of the investment material containing a reducing agent such as carbon) the resulting paste in the form of the restoration to be made, heating the resulting composite to a temperature sufficient to sinter the powder of dental metal to a massive metal mass and, optionally, finishing the resulting substructure at the surface.

In another example a ceramic may then be pressed into the model negative (restoration mold) through the void left by the pedestal. This may be accomplished by first selecting the amount and size of ceramic ingots needed to form the restoration. This is calculated based on the measured wax weight. Typically, ceramic manufacturers provide charts correlating the size and number of ingots to use with the measured weight of the wax. The ceramic ingot is then placed into the hole in the refractory cylinder. A plunger is then placed into the hole above the ceramic. The plunger is typically made of aluminum oxide although other refractory materials may be used. The plunger is then used to force the ceramic into the restoration mold. The pressing process typically stops when ceramic fills the voids left by the model and the sprue. This whole process typically takes place in a press furnace. The pressing of the ceramic typically takes place at high temperatures up to 1200° C. (2192° F.) and optionally under a vacuum or partial vacuum. Press furnaces can be preprogrammed with certain heating and vacuum press cycles for different types and amounts of ceramic. The ceramic ingot and plunger may also be preheated before being placed into the refractory cylinder.

After the mold is removed from the press furnace and cooled, the next step involves the divesting of the investment cylinder from the ceramic restoration. This may be accomplished by cutting the investment cylinder with a separating disk at the point where the bottom of the plunger lies. This point is estimated by placing an identical plunger next to the embedded plunger and marking on the refractory cylinder surface the end of the plunger. The investment cylinder may be cut all along its circumference and then the material may be pried off using a plaster knife or similar tool. The remaining investment material may be then removed with a sandblaster using a suitable abrasive such as alumina, quartz, or glass beads.

The sprue is then removed from the restoration by cutting the sprue near its base using a diamond disk or otherwise. The remaining material, if present, may be then removed using a ceramic stone or other abrasive. The ceramic restoration can then be fit on the stone model after removing the spacer and acute adjustments can be made as required.

As discussed above, the present invention provides materials and methods of manufacturing dental restorations using blocks or blanks of material prepared in a variety of shapes and sizes to be used in the fabrication of dental restorations. The material may comprise any sintered ceramic material. Useful ceramic materials are refractory, not reactive, and essentially inert during subsequent firing steps. Sinterable refractory ceramic materials thus include but are not limited to quartz, cristobalite, other forms of silica, leucite, various forms of zirconia, hafnia, zircon, alumina, magnesia, aluminosilicate, cordierite, mica, silicon nitride, silicon carbide, silica-alumina-nitrides, mullite, various garnets, or mixtures thereof.

It is often useful to formulate the investment (e.g., refractory) ceramic materials with one or more binders, which may be either organic or inorganic. Organic binders are well known, for example, polyvinyl pyrrolidine, polyvinyl alcohol, polyvinyl acetate, polyvinyl chloride, polyvinyl butryal and polystyrene, and mixtures thereof. Inorganic binders are known and may include but are not limited to metal oxides (e.g., magnesium oxide), soluble phosphate (e.g., phosphate dust, ammonium phosphate, mono-ammonium phosphate (MAP), or otherwise), colloidal silica, calcium sulfate (hemihydrates or dehydrate such as gypsum), ammonium sulfate, sodium phosphate, ethyl silicate, sodium silicate, silica, magnesium phosphate, silica compounds (e.g., alkaline silicates and silica hydrosol), colloidal clays, or otherwise and mixtures thereof.

The binder may be present in an amount of at least about 3%, preferably at least about 5%, and more preferably at least about 10% by weight of the investment composition. Furthermore, the binder may be present in an amount of less than about 65%, preferably less than about 55% greater, and more preferably less than about 45% by weight of the investment composition. For example, the binder may be present in an amount ranging from about 3% to about 65%, preferably from about 5% to about 55%, and more preferably from about 10% to about 45% by weight of the investment composition. In one specific embodiment, the one or more binders includes a first binder (e.g., metallic oxides such as magnesium oxide) ranging from about 1% to about 30% (e.g., from about 3% to about 20%) by wt of the investment composition and a second binder (e.g., phosphate dust such as ammonium phosphate) ranging from about 1% to about 30% (e.g., from about 3% to about 20%) by wt of the investment material.

Refractory materials and investment refractory materials are particularly useful in the formation of ceramic materials and cast alloys. Investment refractory materials useful herein include gypsum-bonded, phosphate-bonded and ethyl silicate-bonded investment materials. These investment materials may include, but are not limited to quartz (e.g., quartz silica (crystalline)), cristobalite (e.g., cristobalite (crystalline)), tridymite, or other forms of silica, leucite, various forms of zirconia, hafnia, zircon, alumina, magnesia, or otherwise and mixtures thereof. Other examples of refractory materials may include a mixture of a filler and a bonding agent.

The refractory material may be present in an amount of at least about 25%, preferably at least about 35%, and more preferably at least about 45% by weight of the investment composition. Furthermore, the refractory material may be present in an amount of less than about 95%, preferably less than about 90% greater, and more preferably less than about 85% by weight of the investment composition. For example, the refractory material may be present in an amount ranging from about 25% to about 95%, preferably from about 35% to about 90%, and more preferably from about 45% to about 80% by weight of the investment composition. In another specific embodiment, the one or more refractory materials may include a first refractory material (e.g., quartz such as quartz silica (crystalline)) ranging from about 30% to about 75% (e.g., from about 35% to about 65%) by wt of the investment composition and a second refractory material (e.g., cristobolite such as cristobalite (crystalline)) ranging from about 3% to about 60% (e.g., from about 5% to about 35%) by wt of the investment material.

The investment composition may include one or more additives. Examples of additives may include, are not limited to, fillers, colorants, fluxes (e.g., boric oxide), stabilizer or modifiers, and/or otherwise. When included, the additives may be based on alumina, zirconia, magnesia, zircon, aluminosilicate, cordierite, mica, sodium chloride, boric acid, potassium sulfate, copper powder, or otherwise, and mixtures thereof.

The additive may be present in an amount of at least about 0.05%, preferably at least about 0.5%, and more preferably at least about 1% by weight of the investment composition. Furthermore, the additive may be present in an amount of less than about 75%, preferably less than about 50% greater, and more preferably less than about 25% by weight of the investment composition. For example, the additive may be present in an amount ranging from about 25% to about 95%, preferably from about 35% to about 90%, and more preferably from about 45% to about 80% by weight of the investment composition.

It is believed that during the formation of the restoration in an investment that is free of a reducing agent, a reaction (e.g., a partial or complete reaction) between the restoration material (e.g., lithium-silicate based materials such as lithium monosilicate glass ceramics, lithium disilcate glass ceramics, or otherwise) and the investment material may occur. This reaction with the investment material that is free of a reducing agent may form an undesirable reaction layer (e.g., reaction layer) about the surface of the formed restoration. Typically, one or more additional manufacturing steps may be needed to remove the reaction layer from the surface of the formed restoration, which may include, but are not limited to, acid dipping (e.g., acid etching) using hydrofluoric acid, sulphuric acid, or otherwise (e.g., Invex liquid), sand blasting (e.g., Al₂O₃), polishing aids (e.g., using beads such as glass polishing beads), ultrasonic cleaner, grinding, or otherwise.

Advantageously, it has been found that by adding a reducing agent to the investment composition, formation of the reaction layer may be reduced or substantially eliminated. More particularly, the reducing agent may reduce oxidation (e.g., reactive tendencies) or provide a substantially protective atmosphere between the investment material and the restoration material. In one specific example, the presence of carbon as the reducing agent may react with the reactive atmosphere (e.g., oxygen) to form a carbonation layer along the inner void of the investment mold. The formation of the carbonation layer may reduce the presence of the reactive atmosphere thereby limiting the available reactive atmosphere necessary to the formation of the reaction layer. Desirably, by limiting the available reactive atmosphere, reaction between the investment material and the restoration may be reduced thereby reducing the formation of the reaction layer.

When included, the reducing agent may reduce or substantially eliminate the formation of the reaction layer so that the reaction layer may be present having a thickness less than 100 microns, preferably less than 50 microns, and more preferably less than 30 microns along the surface of the formed restoration. More particularly, the formation of the reaction layer may be reduced or substantially eliminated along the surface of the resultant restoration formed from the investment material (e.g., heat resistant material) containing carbon of the present invention as compared to a restoration formed from a investment material (e.g., heat resistant material) being free of a reducing agent containing carbon. For example, the reducing agent may reduce or substantially eliminate the formation of the reaction layer so that the reaction layer may be present having a thickness ranging from about 0 microns to about 100 microns (e.g., from about 0.5 microns to about 100 microns), preferably from about 0 microns to about 50 (e.g., from about 0.5 microns to about 50 microns), and more preferably from about 0 microns to about 30 microns (e.g., from about 0.5 microns to about 30 microns or from about 0.5 microns to about 10 microns) along the surface of the formed restoration.

In doing so, the reduction and/or elimination of the reaction layer may allow for fewer manufacturing steps that may have been necessary for the compete removal of the reaction layer resulting from an investment material free of a reducing agent (e.g., reducing agent containing carbon). More particularly, when the formation of the reaction layer may be reduced (e.g., resulting from the application of an investment material having a reducing agent containing carbon such as graphite or otherwise) to a thickness less than 100 microns, preferably less than 50 microns, and more preferably less than 30 microns along the surface of the formed restoration, the removal step of acid dipping (e.g., using hydrofluoric acid, sulphuric acid, or otherwise such as an Invex liquid) may be eliminated from the manufacturing steps for forming the finished restoration.

It is appreciated that the formation of the restoration using the investment material having a reducing agent containing carbon may result in the formation of a carbonation layer between the investment material and the restoration thereby reducing or substantially eliminating the formation of the reaction layer along the surface of the resultant restoration. Desirably, the carbonation layer and/or the reduced reaction layer may be removed from the resultant restoration by polishing aids, sand blasting, and/or otherwise without requiring the acid dipping and/or acid etching step for removal thereof.

Examples of reducing agents include but are not limited to, carbon such as carbon black (e.g., Ivory black, vine black, or lamp black), graphite, graphite intercalation compounds (e.g., XC₈ for the large metals (X=K, Rb and Cs) and XC₆ for small ones (X=Li, Sr, Ba, Eu, Yb and Ca), graphene, or combinations thereof. In one preferred embodiment, the reducing agent may include graphite. Graphite, when included, may include a carbon content ranging from about 50% to about 100% (e.g., from about 75% to about 100%, and preferably from about 90% to about 100%), though not required. Optionally when included, graphite may further include an ash content ranging from about 0.05% to about 10% (e.g., from about 1% to about 8%, and preferably from about 4% to about 6%). Desirably, the reaction layer may be substantially reduced or completely eliminated during the formation of a restoration when utilizing an investment composition (e.g., phosphate-based investment composition) including a reducing agent (e.g., graphite).

The reducing agent may be present in an amount of at least about 0.5%, and preferably at least about 1% by weight of the investment composition. Furthermore, the reducing agent may be present in an amount of less than about 50%, preferably less than about 25%, and more preferably less than about 15% by weight of the investment composition. For example, the reducing agent may be present in an amount ranging from about 0.5% to about 50%, preferably from about 0.5% to about 25%, and more preferably from about 1% to about 15% (e.g., from about 1% to about 10%) by weight of the investment composition.

The investment composition may further include one or more liquid components. The liquid component may be added to a mixture of the dry components (e.g., powdered components such as the binder, refractory material, the reducing agent, the additive or otherwise) to form the investment composition. Optionally, the liquid component may be added to one or more of the dry components to form individual preblends and then each individual preblend may be mixed together to form the investment composition. Examples of the liquid components include, but are not limited to, water (e.g., distilled water), amorphous silica (e.g., colloidal silica or alkali stabilized colloidal silicic acid), gycol (e.g., ethylene gycol), or otherwise and mixtures thereof.

The liquid component may be present in an amount of at least about 5%, preferably at least about 10%, and more preferably at least about 15% by weight of the investment composition. Furthermore, the liquid may be present in an amount of less than about 45%, preferably less than about 40% greater, and more preferably less than about 35% by weight of the investment composition. For example, the liquid may be present in an amount ranging from about 5% to about 45%, preferably from about 10% to about 40%, and more preferably from about 15% to about 35% by weight of the investment composition. In another specific embodiment, the liquid component may include more or more liquids including a first liquid component (e.g., amorphous silica) ranging from about 5% to about 35% (e.g., from about 10% to about 30%) by wt of the investment composition and a second liquid component (e.g., water such as distilled water) ranging from about 1% to about 30% (e.g., from about 3% to about 20%) by wt of the investment material.

It is appreciated that the application of the reducing agent may be provided as a preblend with one or more of the binder, the refractory material, the additive, and/or the liquid component, along the surface of the interior void of the formed investment, along the surface of the wax build-up, within the composition of the ingot, about the surface of the ingot (e.g., ceramic ingot), or otherwise, and combinations thereof.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed:

1. An investment composition comprising a reducing agent containing carbon.

2. The investment composition of claim 1, wherein the reducing agent is graphite.

3. The investment composition of claim 2, wherein the reducing agent is present in an amount ranging from about 0.5% to about 25%

4. The investment composition of claim 3, further comprising at least one binder and at least one refractory material, wherein the at least one binder is present in an amount ranging from about 3% to about 65% and the at least one refractory material is present in an amount ranging from about 25% to about 95%.

5. The investment composition of claim 1, further comprising at least one binder and at least one refractory material.

6. The investment composition of claim 5, wherein the at least one binder is present in an amount ranging from about 3% to about 65% and the at least one refractory material is present in an amount ranging from about 25% to about 95%.

7. The investment composition of claim 6, wherein the reducing agent graphite and is present in an amount ranging from about 0.5% to about 50%.

8. The investment composition of claim 6, wherein the at least one binder includes a first binder and a second binder that is different from the first binder and the at least one refractory material includes a first refractory material and a second refractory material that is different from the first refractory material.

9. The investment composition of claim 8, wherein the first binder is present in an amount ranging from about 1% to about 30% and the second binder is present in an amount ranging from about 1% to about 30% and the first refractory material is present in an amount ranging from about 30% to about 75% and the second refractory material is present in an amount ranging from about 3% to about 60%.

10. The investment composition of claim 9, further comprising one or more liquid components being present in an amount ranging from about 5% to about 45%.

11. The investment composition of claim 10, wherein the reducing agent is graphite and is present in an amount ranging from about 0.5% to about 15%.

12. A method for manufacturing a dental restoration comprising the steps of:
creating a wax model;
providing a heat-resistant material comprising a reducing agent containing carbon,
applying the heat resistant material to the wax model;
heating the wax model covered with the heat resistant material so that the wax is burnt off thereby forming a heat resistant mold having a void therein;
providing a restoration material into the void of the heat resistant mold; and
forming a resultant restoration in the void of the heat resistant mold;
wherein the formation of a reaction layer is reduced or substantially eliminated along the surface of the resultant restoration as compared to a restoration formed from a heat resistant material being free of a reducing agent containing carbon.

13. The method of claim 12, wherein the reducing agent is graphite.

14. The method of claim 13, wherein the reducing agent is present in an amount ranging from about 0.1% to about 25% by wt of the heat-resistant material.

15. The method of claim 12, wherein the heat-resistant material further comprises at least one binder and at least one refractory material, the at least one binder is present in an amount ranging from about 10% to about 45% by wt of the heat-resistant material and the at least one refractory material is present in an amount ranging from about 45% to about 80% by wt of the heat-resistant material.

16. The method of claim 15, wherein the reducing agent is graphite and is present in an amount ranging from about 0.5% to about 15% by wt of the heat-resistant material.

17. The method of claim 15, wherein the at least one binder includes a first binder and a second binder that is different from the first binder, the first binder is present in an amount ranging from about 1% to about 30% by wt of the heat-resistant material and the second binder is present in an amount ranging from about 1% to about 30% by wt of the heat-resistant material.

18. The method of claim 17, wherein the at least one refractory material includes a first refractory material and a second refractory material that is different from the first refractory material, the first refractory material is present in an amount ranging from about 30% to about 75% by wt of the heat-resistant material and the second refractory material is present in an amount ranging from about 3% to about 60% by wt of the heat-resistant material.

19. The method of claim 18, wherein the heat-resistant material further comprises one or more liquid components being present in an amount ranging from about 15% to about 35%.

20. The method of claim 19, wherein the reducing agent is graphite and is present in an amount ranging from about 0.5% to about 15% by wt of the heat-resistant material.

21. The method of claim 12, wherein the reducing agent reduces the formation of the reaction layer so that the reaction layer is present having a thickness ranging from about 0.5 microns to about 30 microns along the surface of the resultant restoration.

22. The method of claim 12, wherein the method is free of an acid etching step.

23. An investment composition comprising:
from about 0.5% to about 10% by wt graphite;
from about 10% to about 45% by wt at least one binder;
from about 45% to about 80% by wt at least one refractory material; and
from about 15% to about 35% by wt at least one liquid component.

24. The investment composition of claim 23, wherein the at least one binder includes a first binder ranging from about 3% to about 20% by wt of the investment composition and a second binder ranging from about 3% to about 20% by wt of the investment material and the at least one refractory material includes a first refractory material ranging from about 35% to about 65% by wt of the investment composition and a second refractory material ranging from about 5% to about 35% by wt of the investment material.

25. The investment composition of claim 24, wherein the at least one liquid component includes a first liquid component ranging from about 10% to about 30% by wt of the investment composition and a second liquid component ranging from about 3% to about 20% by wt of the investment material.
